(19) United States
(12) Patent Application Publication
(10) Pub. No.: US 2007/0159098 A1
(43) Pub. Date: Jul. 12, 2007

(54) EL panel

(75) Inventor: Junichi Seki, Tokyo (JP)

Correspondence Address: OLIFF & BERRIDGE, PLC, P.O. BOX 19928, ALEXANDRIA, VA, 22320, US

(73) Assignee: TDK CORPORATION, Tokyo (JP)

(21) Appl. No.: 11/646,561

(22) Filed: Dec. 28, 2006

(30) Foreign Application Priority Data
Dec. 28, 2005 (JP) P2005-379360

(51) Int. Cl. H05B 33/04

(52) U.S. Cl. 313/512

(57) ABSTRACT

The object of the present invention is to provide an EL panel that fully attains the intrinsic light-emitting property and that sustains stable light-emitting property. The EL panel 10 in a preferred embodiment of the present invention has a substrate 2, an EL element 4, a passivation film 5 formed on an upper surface of the EL element 4, a protective layer 6 covering the EL element 4, and a seal plate 8, in this order. The protective layer 6 contains an optical cation-curing type resin and an acid-trapping agent.

### BACKGROUND OF THE INVENTION

1. Field of the Invention

The present invention relates to an EL panel which protects EL element with a cover of resin-made protective layer.

2. Related Background Art

Electro luminescence (EL) elements such as organic EL and inorganic EL are self-emission type light-emitting elements, having features of high brightness and easy to reduce size and weight. They are expected to be applied in the fields of display, lighting, and the like. The light-emitting materials used for these EL elements, however, likely deteriorate their emission property by external atmosphere (particularly by water such as moisture), and the drawback becomes a cause of hindering the long service life of the elements. Consequently, the conventional EL elements are in a form of EL panel with sealed EL element to reduce the occasions of exposure to external atmosphere.

There is a known sealing method of hollow-type sealing, which positions the EL element between a substrate and a seal plate, while plugging only the outer periphery of them by a sealing agent made of a resin and the like. The hollow-type sealing, however, often needs to place a desiccant therein to completely remove moisture in the hollow section, which makes it difficult to design the EL panel in a small and thin shape.

To reduce the drawbacks, there is known a structure of solid sealing, which does not leave the zone containing the EL element between the substrate and the seal plate hollow, but fills the whole zone with a curing resin as an adhesion layer. Since that type of structure completely seals the surrounding area of the EL element, very little moisture and other water content enter or are left behind, and no desiccant is required. For the material to form that type of adhesion layer, there is adopted an epoxy resin which has characteristics of favorably adhering the substrate with the seal plate, and of low water permeability.

Use of a thermosetting epoxy resin as the material to form the adhesion layer, however, brings the resin to extremely low viscosity before curing caused by the heating during thermosetting. Since the resin in low viscosity readily penetrates into the EL element, it may damage the EL element. Although there is applied, in some cases, a film of inorganic oxide or the like, (passivation film), on the top of EL element to protect the electrode made of ITO and the like, the film is also difficult to fully prevent the penetration of the low viscosity resin. If the EL element is once damaged, the intrinsic light-emission of the EL element cannot be fully attained, thus resulting in the decrease of emission brightness and the decrease of light-emitting area on the EL panel.

To avoid that kind of drawbacks, optical cation-curing type epoxy resins are used as the material for forming the adhesion layer, (adhesion resin), (refer to Japanese Patent Application Laid-Open No. 2003-197366, for example). Since the optical cation-curing type resins do not need to be heated during curing, the above low viscosity is not induced, and they give little damage to the EL element caused by the penetration of the resin.

### SUMMARY OF THE INVENTION

When the adhesion layer is formed using the above optical cation-curing type resin, however, the obtained EL panel significantly deteriorates the light-emitting property with time, and is difficult to sustain the good light-emitting property for a long period of time, though the damage of EL element suffering during the manufacture of EL panel is reduced.

Therefore, the present invention has been made in view of the foregoing situation, and an object of the present invention is to provide an EL panel that fully attains the intrinsic light-emitting property of the EL element and that sustains stable light-emitting property.

The inventors of the present invention conducted detail study about the causes of deterioration of light-emitting property of EL panel with time with the use of an optical cation-curing type epoxy resin as the adhesion layer, and found that the deterioration of light-emitting property is caused by an acid which is a byproduct of curing reaction of the optical cation-curing type epoxy resin. That is, the optical cation-curing type resin contains an optical cation-curing agent, and the curing agent generates an acid under irradiation of light. Then, the generated acid acts as a catalyst to induce polymerization of monomer components, thereby progressing the curing of the optical cation-curing type resin.

Since the acid generated during the curing reaction is generally not removed after completing the curing reaction, the acid is left in the adhesion layer. The EL element (specifically the electrode constituting the element) and the passivation film for protecting the EL element are, however, readily corroded by acids. Accordingly, it was found that, if an acid is left in the adhesion layer, the EL element closely contacting with the adhesion layer is gradually corroded by the acid, and the deterioration of light-emitting property of the EL panel proceeds with time.

On the basis of the finding, the inventors of the present invention found that the corrosion of EL element can be suppressed and the light-emitting property of EL panel can be stably maintained if only the effect of the acid left in the adhesion layer decreases, and have perfected the present invention.

That is, the EL panel according to the present invention has a substrate, an EL element mounted on the substrate, and a protective layer being formed on the substrate so as to cover at least a part of the EL element, while the protective layer contains an optical cation-curing type resin and an acid-trapping agent.

The acid-trapping agent is a component which traps an acid component in the protective layer, or which can deactivate the acid-trapping agent within the protective layer through the reaction with the acid component to convert into neutral or basic property. According to the EL panel of the present invention, the protective layer contains an optical cation-curing type resin and the above acid-trapping agent. Consequently, even if an acid generated during the curing reaction of the optical cation-curing type resin is left in the protective layer, the acid is trapped or neutralized by the acid-trapping agent. As a result, in the EL panel according to the present invention, the deterioration of light-emitting property with time caused by the corrosion of the EL element becomes small in spite of the structure of the protective layer, containing the optical cation-curing type resin adhered to the EL element. Regarding the EL panel according to the present invention, the protective layer may be formed directly on the EL element, or may indirectly contact with the EL element via the passivation film or the like.

Specifically, the acid-trapping agent is preferably a salt of alkali earth metal. That salt of alkali earth metal is able to favorably neutralize the acid in the protective layer.

The acid-trapping agent preferably exists in an amount from 2 to 10 parts by mass to 100 parts by mass of the optical cation-curing type resin. Excessively small amount of acid-trapping agent likely fails to attain full effect of deactivation of acid, and excessively large amount thereof tends to deteriorate the characteristics (moisture-proof, and the like) as the protective layer. Consequently, the above content range allows surely attaining the effect of the acid-trapping agent while sustaining the good property of the protective layer, thus further improving the reliability of the EL panel.

For the EL panel according to the present invention, the optical cation-curing type resin in the protective layer preferably has degree of curing ranging from 30 to 70%. Here, the degree of curing is an index of progress of curing, determined by subtracting the temperature-dependency from an ion viscosity curve which is derived from the dielectric loss factor obtained by the dielectric analysis (DEA) of the optical cation-curing type resin. The degree of curing is the value in relation to the value of flat portion of the ion viscosity curve counting as 100% (complete curing).

Since the optical cation-curing type resin with 30 to 70% of degree of curing does not completely progress the curing reaction, the content of acid generated during curing becomes small compared with that in the completely cured resin. Therefore, the protective layer containing that kind of optical cation-curing type resin contains only a small amount of acid, and contains the acid-trapping agent, which makes the EL element and the like further resistant to corrosion. In addition, the optical cation-curing type resin having above degree of curing has a characteristic of softness compared with the case of complete curing. Therefore, the protective layer can favorably relax the stress generated during curing reaction. As a result, the break of EL element is significantly decreased, which EL element conventionally likely broken caused by the stress between the protective layer and the EL element in the case of forming a hard protective layer.

### BRIEF DESCRIPTION OF THE DRAWINGS

FIG. 1 is a schematic drawing of cross sectional structure of an EL panel of a preferred embodiment.

FIG. 2 is a graph showing the changes of light-emitting area with time on the respective EL panels of Examples 1 to 4 and Comparative Example 1.

FIG. 3 is a graph showing the changes of light-emitting area with time on the respective EL panels of Examples 5 to 9.

### DESCRIPTION OF THE PREFERRED EMBODIMENTS

Preferred embodiments of the present invention are described below referring to the drawings.

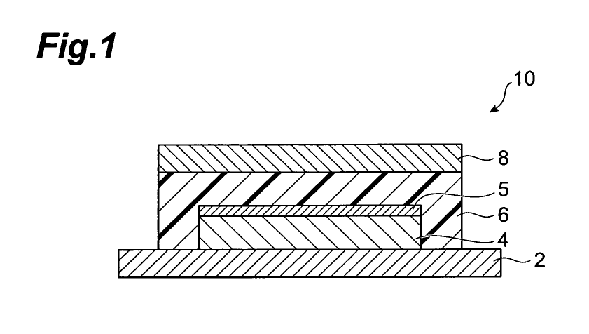

FIG. 1 is a schematic drawing of cross sectional structure of the EL panel of a preferred embodiment. As seen in FIG. 1, an EL panel 10 has a structure including a substrate 2, an EL element 4 formed on the substrate 2, a passivation film 5 mounted on the upper face of the EL element 4, a protective layer 6 formed on the substrate 2 so as to cover the EL element 4, and a seal plate 8 arranged facing the substrate 2 and sandwiching the protective layer 6 with the substrate 2. In the embodiment, the description is given to the EL panel 10 which has a structure of top-emission type that allows the light of the EL element 4 to emit from the seal plate 8 side.

The substrate 2 also functions as the substrate for the EL element 4, and has no specific limitation if only it is ordinarily used as the substrate for EL element. Examples of the material for the substrate 2 are glass substrate, silicon substrate, film substrate, and organic substrate represented by resin substrate. The seal plate 8 is made of a transparent material which allows the EL element 4 to emit light therethrough. Examples of the material for the seal plate 8 are glass and plastics.

To the EL element 4, either of an organic EL element and an inorganic EL element may be applied. Those EL elements have a laminated structure of, for example, on the substrate 2, a lower electrode, an upper electrode, and a light-emitting layer made of an organic or inorganic light-emitting body being positioned between these electrodes. Other layer may be placed at an adequate position in the laminated structure depending on the desired characteristics.

The lower electrode and the upper electrode may use a transparent electrode composed of ITO, IZO, and the like at the side of emitting the light (at the upper electrode for the embodiment). To opposite side therefrom, an electrode made of metal such as aluminum can be applied instead of the above transparent electrode. The light-emitting body may be the one made of a low molecular weight or high molecular weight organic compound as the organic light-emitting body without specific limitation. Examples of inorganic light-emitting body are the ones composed of the main material made of an inorganic compound, to which a light-emitting center such as metal is doped.

The passivation film 5 is mounted to cover the upper face of the EL element 4 to function as the protector of the upper electrode and the like of the EL element 4. That type of passivation film 5 may be made of metal oxide, metal nitride, oxynitride, and the like. Examples of the passivation film 5 are the ones composed of SiOx or SiON.

The protective layer 6 is sandwiched between the substrate 2 and the seal plate 8, while containing the EL element 4 therein. The protective layer 6 is structured mainly by an optical cation-curing type resin, and further contains an acid-trapping agent. The optical cation-curing type resin is a material formed by polymerization and curing of the raw material composition (monomer component, curing agent, and the like), and has a structure of cross-linked polymer generated by the polymerization. The optical cation-curing type resin that structures the protective layer 6 may be, as described later, the one not completely cured, and may contain monomer component before polymerizing, curing agent, and the like, and further an oligomer component formed by polymerization of them.

The optical cation-curing type resin is preferably an optical cation-curing type epoxy resin. Examples of that type of resin are the ones prepared from epoxy resin such as alicyclic epoxy resin, bisphenol-type epoxy resin, and novolak-type epoxy resin as the main component, and combining with an optical cation catalyst such as diazonium compound, sulfonium compound, and iodonium compound. Specific examples of the optical cation-curing type epoxy resin are UV cation-curing type epoxy resin XNR5570 and XNR5516 of Nagase ChemteX Corporation, and Three Bond 3124 of Three Bond Co., Ltd.

The curable resin in the protective layer 6 preferably has degree of curing in a range from 30 to 70%, and more preferably from 40 to 60%. If the degree of curing is below 30%, the protective layer 6 becomes excessively soft, and the full protection of the EL element 4 likely fails. The curable resin may be completely cured one (degree of curing of 100%). However, the degree of curing of below 70% results in less amount of acid generated during curing, which is preferable because the corrosion of EL element 4 by the acid is surely suppressed.

As described above, the acid-trapping agent is a component which can deactivate the acid component within the protective layer through the trapping of acid component in the protective layer or through the reaction with the acid component to bring the composition to neutral or basic property. That type of acid-trapping agent includes metal salt, metal oxide, or clay compound, which expresses basicity. Among these, specifically preferred one is a salt of alkali earth metal, such as carbonate, phosphate, and hydrogen phosphate of these alkali earth metals.

Examples of preferred acid-trapping agent are calcium carbonate, calcium phosphate, magnesium carbonate, hydrogen magnesium phosphate, magnesium oxide, strontium carbonate, and hydrotalcite. Among these, hydrogen magnesium phosphate is specifically preferred.

The preferred acid-trapping agent is preferably selected depending on the kind of optical cation-curing type resin in the protective layer 6. A preferable combination of the optical cation-curing type resin and the acid-trapping agent is the one in which the characteristic of extract of the cured product containing them is preferably pH 6 or more, more preferably pH 6 to 8, and most preferably from pH 6 to 7. The characteristic of extract is the value obtained by mixing and curing the optical cation-curing type resin with the acid-trapping agent, and by treating the cured product with water to extract the water-soluble components in the cured product into water, followed by determining the pH of the treated water. The value is defined as the value obtained from treating 10 g of cured product with 50 mL of water, followed by diluting the extract to 100 mL. That characteristic of extract can be adjusted by varying the mixing ratio of the optical cation-curing type resin to the acid-trapping agent, and the combination of them.

If the characteristic of extract is below pH 6, the acid-trapping agent presumably fails in fully deactivating the acid in the cured product. As a result, sufficient acid-trapping effect to the optical cation-curing type resin cannot be attained, and the full suppression of the corrosion of EL element 4 in the EL panel 10 is likely not attained. If the pH exceeds 8, the acid-trapping agent exists in an excess amount in the cured product, which increases the electric conductivity of the extract, and then likely generates defects such as leakage.

In view of surely attaining the effect of the acid-trapping agent, the content of acid-trapping agent in the protective layer 6 is preferably 2 to 10 parts by mass to 100 parts by mass of the optical cation-curing type resin, and more preferably in a range from 2 to 6 parts by mass. If the content of the acid-trapping agent is within a range from 2 to 10 parts by mass, the above characteristic of extract easily falls in a favorable range, and the corrosion of EL element 4 by the acid in the protective layer 6 becomes favorably suppressed.

A preferred method for manufacturing the EL panel 10 having the above structure is described below.

The substrate 2 is first prepared. The EL element 4 is formed on the substrate 2. Subsequently, on the EL element 4, for example, on the upper electrode positioned on the uppermost part of the EL element 4, the passivation film 5 composed of SiOx, SiON, and the like is formed by the sputtering method, the chemical vapor deposition (CVD) method, the sol-gel method, and the like.

After that, the raw material composition containing the not-cured optical cation-curing type resin (a composition containing monomer component and curing agent) and the acid-trapping agent is applied onto the substrate 2 using the dropping method using a dispenser, the screen printing method, and the like to form a layer of the raw material composition so as to cover at least the EL element 4. The raw material composition can be prepared by adding the acid-trapping agent to the optical cation-curing type resin, which are then mixed and kneaded by a three-roll mill, a ball mill, a planetary mixer, a beads mill, and the like.

Then, the seal plate 8 is attached to the substrate 2 via the layer of raw material composition. To thus prepared structure, an activated light is irradiated from the side of seal plate 8 which allows penetration of the light, thus to cure the optical cation-curing type resin in the raw material composition to form the protective layer 6. Through these steps, the EL panel 1 having the structure given in FIG. 1 is obtained. Here, the activated light is a light having energy capable of causing polymerization reaction of the optical cation-curing type resin, and an example of the light is ultraviolet (UV) light. As the UV light, a light emitted from a high pressure mercury vapor lamp may be applied.

On curing a curable resin, the degree of curing is preferably regulated to a range from 30 to 70% by adjusting the irradiation condition of the activated light. Specifically, the degree of curing can be controlled by adjusting the quantity of irradiation, the irradiation time, irradiation temperature, and the like, of activated light. Suitable irradiation condition can be determined by preliminarily measuring the degree of curing using the same optical cation-curing type resin under various conditions.

Determination of the degree of curing of optical cation-curing type resin can be done by the dielectric analysis (DEA) using the resin concerned. That is, the optical cation-curing type resin is positioned between a pair of electrodes, and an alternate voltage is applied to one of the electrodes. Based on the resulting variations of phase and amplitude of response on the other electrode, the dielectric characteristics such as dielectric constant and dielectric loss are derived. From thus obtained dielectric loss, the ion viscosity curve which is a parameter of the migration of ions independent of the frequency is drawn. By subtracting the temperature dependency from the ion viscosity variations, the curve indicating the changes in the degree of curing is drawn. By counting the point, at which thus obtained ion viscosity curve becomes flat, as 100% degree of curing, the value of the degree of curing concerned is determined. That type of dielectric analysis can be given by DEA System (DEA230, DEA231) of NETZSCH.

The above description is given to the EL panel and to the method for manufacturing the EL panel relating to the preferred embodiment of the present invention. The present invention, however, is not limited to the above embodiment, and modifications can be given within the range not departing from the spirit of the present invention.

In the above EL panel 10, the seal plate 8 is first arranged on the protective layer 6. The seal plate 8 is, however, not necessarily required. For the case that sole protective layer 6 fully protects the EL element 4, the seal plate 8 may not be applied. The passivation film 5 on the EL element 4 is not necessarily required. Even with a structure having no passivation film 5, the corrosion of EL element 4 caused by the acid in the protective film 6 can be sufficiently reduced. It is preferable to directly form the protective layer 6 on the EL element 4 from the viewpoint of simplifying the structure of EL panel 10 and of efficiently obtaining the emitting light from the EL element 4.

Further, the EL panel 10 has the structure of top-emission type, in the above description. However, for example, with the substrate 2 structured by a transparent material, the bottom-emission type EL panel that obtains the light from the substrate 2 side may be used. In this case, the respective materials to structure the substrate 2 and the seal plate 8 may be exchanged each other from those in the above embodiment.

Further, the above embodiment described the EL panel 10 having a minimum number of structural components, as an example. The EL panel may further have other components, as needed. For example, when the EL panel is used for display and the like, a color filter may be added to the seal plate 8 side to colorize the panel.

Furthermore, the above described manufacturing method for the EL panel conducted curing of the curable resin after attaching the seal plate 8 to the substrate 2. However, the step is not necessarily limited to the above procedure, and the attaching of the seal plate 8 may be done after curing of the curable resin, or may be done during the curing process. From the viewpoint to assure good adhesion, however, the seal plate is preferably attached before curing the curable resin.

### EXAMPLES

The present invention is described below in more detail referring to the examples. The present invention, however, is not limited to these examples.

[Determination of the Characteristic of Extract]

The characteristic of extract for the protective layer containing the UV cation-curing type resin and the acid-trapping agent, with the combination applied in the following examples, was evaluated as follows. First, magnesium carbonate (MgCO₃) as the acid-trapping agent was mixed with the UV cation-curing type epoxy resin (XNR5570, manufactured by Nagase ChemteX Corporation). Then, to the mixture, UV irradiation at 12000 mJ/cm² and heating at 80° C. were applied to cure the UV cation-curing type resin by the light and the heat. Thus obtained cured product was used as the sample for determination of the characteristic of extract.

A 10 g aliquot of the sample was added to 50 mL water to agitate the mixture. After agitation, the mixture was filtered to separate the cured product from water. The filtrate was diluted to 100 mL, and the pH of the diluted filtrate was determined by a pH meter. Thus determined pH value was adopted as the characteristic of extract.

The determination was given to the individual samples prepared by adding the acid-trapping agent to 100 parts by mass of the optical cation-curing type epoxy resin by the quantities of 1, 2, 10, 20, and 30 parts by mass, respectively. The characteristic of extract for the cases of 1, 2, 10, 20, and 30 parts by mass of the acid-trapping agent were pH4, pH6, pH7, pH8, and pH10, respectively.

[Fabrication of EL Panel]

(Example 1) An organic EL element was first formed on the substrate. A 1 part by mass of magnesium carbonate (MgCO₃) as the acid-trapping agent was added to 100 parts by mass of the UV cation-curing type epoxy resin (XNR5570, manufactured by Nagase ChemiteX Corporation). The mixture was blended by a three-roll mill to prepare the raw material composition for forming the protective layer. Then, the raw material composition was added dropwise onto the substrate on which the organic EL element was formed. Subsequently, the transparent seal plate was attached to the substrate from the EL element side, not contacting the element. To thus obtained structure, UV curing and thermosetting were applied at 12000 mJ/cm² and 80° C. from the seal plate side to the UV cation-curing type epoxy resin in the raw material composition, thus formed the protective layer. The characteristic of extract of the protective layer was, as described above, pH4. Through these steps, the EL panel having the same structure as that of FIG. 1 except for the absence of passivation film was obtained.

(Examples 2 to 4) The EL panels for Examples 2, 3, and 4 were prepared by the same procedure as that of Example 1 except that the added amount of the magnesium carbonate was 2, 10, and 20 parts by mass, respectively. The characteristic of extract of the protective layer in each EL panel was pH6, pH7, and pH8, respectively.

(Comparative Example 1) The EL panel for Comparative Example 1 was prepared by the same procedure as that of Example 1 expect for not-adding the magnesium carbonate.

[Determination of Changes in Light-Emitting Area with Time]

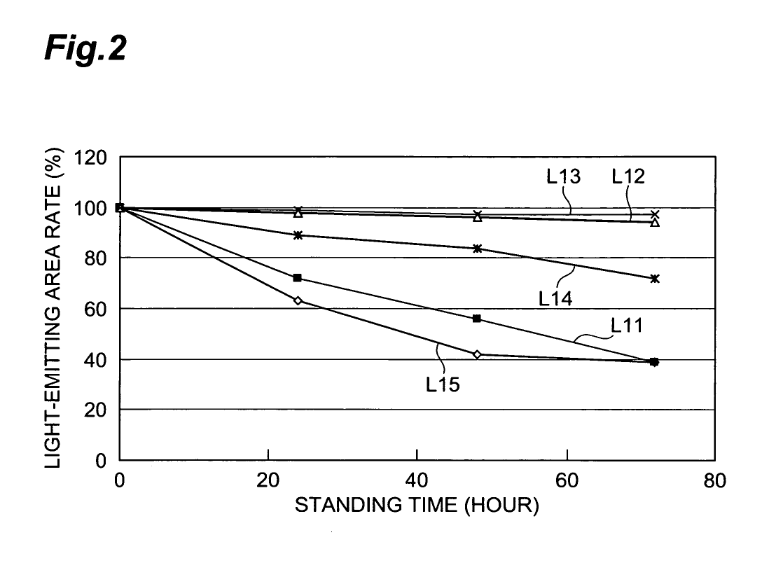

With the EL panels of Examples 1 to 4 and Comparative Example 1, the light-emission test was conducted to determine the reduction of light-emitting zone after specified times. That is, first, by letting the EL panel emit light immediately after the manufacture, the area of the light-emitting zone was determined. Then, the EL panel was allowed to stand at 60° C. and 95% RH, and the area of the light-emitting zone was determined when 24, 48, and 72 hours had passed. Counting the area of light-emitting zone immediately after the manufacture as 100, the area of light-emitting zone (light-emitting area rate) at each of 24, 48, and 72 hours was determined. The result is given in FIG. 2.

FIG. 2 is a graph showing the changes of light-emitting area with time on the respective EL panels of Examples 1 to 4 and Comparative Example 1. In FIG. 2, the symbols L11, L12, L13, L14, and L15 represent the results obtained on the EL panels of Examples 1, 2, 3, 4 and Comparative Example 1, respectively.

FIG. 2 shows that the EL panels of Examples 1 to 4, having the protective layer containing the acid-trapping agent, gave smaller deduction of light-emitting area with time than that of the EL panel of Comparative Example 1, having the protective layer containing no acid-trapping agent.

[Fabrication of EL Panel]

(Example 5) An EL panel was fabricated by the same procedure as that of Example 1 except that the passivation film composed of SiO₂ was formed on the upper face of the EL element using the sputtering method. The characteristic of extract of the protective layer in the EL panel was, as described above, pH4.

(Examples 6 to 9) The EL panels for Examples 6 to 9 were prepared by the same procedure as that of Example 5 except that the added amount of the magnesium carbonate was 2, 10, 20, and 30 parts by mass, respectively. The characteristic of extract of the protective layer in each EL panel was pH6, pH7, pH8, and pH 10, respectively.

[Determination of Changes in Light-Emitting Area with Time]

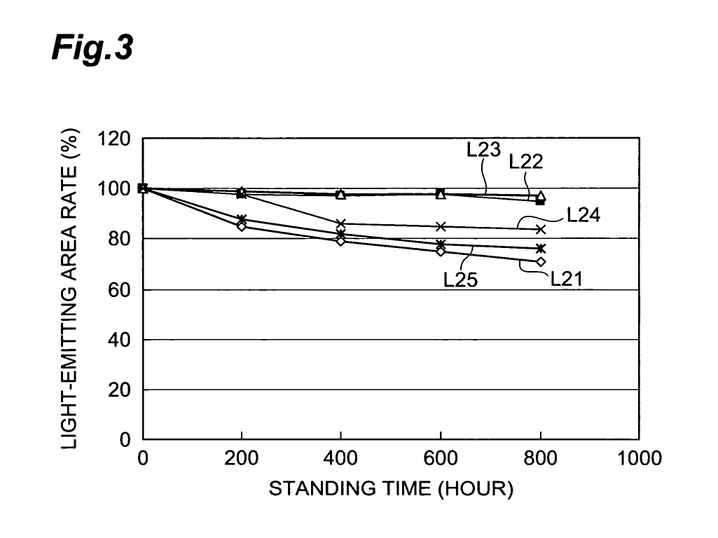

With the EL panels of Examples 5 to 9, the light-emission test was conducted, similar to the above, to determine the reduction of light-emitting zone after specified times. The time to determine the light-emitting area was 200, 400, 600, and 800 hours, respectively. The result is shown in FIG. 3.

FIG. 3 is a graph showing the changes of light-emitting area with time on the respective EL panels of Examples 5 to 9. The symbols L21, L22, L23, L24, and L25 represent the results obtained on the EL panels of Examples 5, 6, 7, 8, and 9, respectively.

FIG. 3 shows that the EL panels of Examples 5 to 9 maintained 70% or more of the light-emitting area rate even after 80 hours had passed. Among these, the EL panels of Example 6 (the characteristic of extract of the protective layer was pH6), Example 7 (pH7), and Example 8 (pH8), and specifically the EL panels of Example 6 and Example 7, gave very little reduction in the light-emitting area rate even after 800 hours had passed.

The present invention provides an EL panel that fully attains the intrinsic light-emitting property of EL element and that sustains stable light-emitting property.

What is claimed is:

1. An EL panel comprising a substrate, an EL element mounted on the substrate, and a protective layer being formed on the substrate so as to cover at least a part of the EL element,
wherein, the protective layer containing an optical cation-curing type resin and an acid-trapping agent.

2. The EL panel according to claim 1, wherein the acid-trapping agent is a salt of alkali earth metal.

3. The EL panel according to claim 1, wherein the quantity of the acid-trapping agent is 2 to 10 parts by mass to 100 parts by mass of the optical cation-curing type resin.

4. The EL panel according to claim 1, wherein the optical cation-curing type resin has a degree of curing ranging from 30 to 70%.
